(19) United States
(12) Patent Application Publication
(10) Pub. No.: US 2025/0377742 A1
(43) Pub. Date: Dec. 11, 2025

(54) CONTROLLER ENGAGEMENT DETECTION USING HYBRID SENSOR APPROACH

(71) Applicant: Apple Inc., Cupertino, CA (US)

(72) Inventors: Kenneth William Tossell, Boulder, CO (US); Erik Arthur Nelson, Castro Valley, CA (US); Chunjia Hu, San Jose, CA (US); Feng Zheng, San Mateo, CA (US); Waleed Abdulla, Mountain View, CA (US); Mohamed Selim Ben Himane, Palo Alto, CA (US)

(73) Assignee: Apple Inc., Cupertino, CA (US)

(21) Appl. No.: 19/179,928

(22) Filed: Apr. 15, 2025

Related U.S. Application Data
(60) Provisional application No. 63/657,739, filed on Jun. 7, 2024.

(51) Int. Cl. G06F 3/038; G06F 3/01; G06F 3/03; G06F 3/0346

(52) U.S. Cl. CPC G06F 3/038; G06F 3/011; G06F 3/0325; G06F 3/0346

(57) ABSTRACT

Techniques are disclosed that enable an electronic device (e.g., a headset) to track a controller and one or more hands of a user wearing the headset by using image recognition and various sensors (e.g., image sensors, motion sensors and proximity sensors) to determine whether the user has picked up and is holding the controller. The input mode of the headset can be switched accordingly.

### CROSS-REFERENCES TO OTHER APPLICATIONS

The present application claims priority to U.S. Provisional Patent Application No. 63/657,739, filed Jun. 7, 2024, which is hereby incorporated by reference in its entirety.

### BACKGROUND

Headsets for virtual reality (VR), augmented reality (AR), and mixed reality (MR) are evolving rapidly, and can offer potential benefits, diverse applications, and abundant opportunities for the future. Controllers and hands are two popular ways of interacting with these realities through the headsets. However, controllers and hands have different advantages. A headset providing both options can enable a better user experience.

### BRIEF SUMMARY

Various techniques are provided for enabling a user of a headset device to use a controller, one or more hands, or switch between the controller and the one or more hands to interact with an application executing on the headset device.

In one general aspect, the techniques may include capturing images using one or more cameras of the headset device. The techniques also include tracking a controller operable to control the headset device using a first model based on the images. The techniques also include tracking one or more hands of a user of the headset device using a second model based on the images. The techniques also include determining a spatial relationship between the one or more hands and the controller. The techniques also include determining the user is holding the controller based on the spatial relationship. The techniques also include responsive to determining the user is holding the controller, switching an input mode of the headset device from a hand mode to a controller mode such that the controller is operable to control the headset device.

Other embodiments are directed to systems, portable consumer devices, and computer readable media associated with techniques described herein. A better understanding of the nature and advantages of embodiments of the present disclosure may be gained with reference to the following detailed description and the accompanying drawings.

### BRIEF DESCRIPTION OF THE DRAWINGS

FIG. 1A is a diagram illustrating an example electronic device (e.g., a headset) operating in a physical environment, in accordance with some embodiments.

FIG. 1B is a diagram illustrating a view, provided via an electronic device (e.g., a headset), of virtual elements within the 3D physical environment of FIG. 1A, in which a user can interact with the virtual elements using hands, in accordance with some embodiments.

FIG. 2 is a diagram illustrating an interaction between a user and the virtual elements of FIG. 1B, provided via an electronic device (e.g., a wearable device such as a head-mounted display (HMD)), using one or more objects (e.g., a controller), in accordance with some embodiments.

FIG. 3 is a diagram illustrating an example controller-tracking model using images and motion data, in accordance with some embodiments.

FIG. 4 is a flow diagram illustrating an example controller-tracking model, in accordance with some embodiments.

FIG. 5 is a flow diagram illustrating an example hand-tracking model, in accordance with some embodiments.

FIG. 6 is a flow diagram illustrating an example architecture of a handheld model for determining whether a user is holding a controller, in accordance with some embodiments.

FIG. 7 is a flow diagram illustrating an example architecture for training a machine learning model to determine whether a user is holding a controller (i.e., handheld model), in accordance with some embodiments.

FIG. 8 illustrates an example machine learning model of a neural network, in accordance with some embodiments.

FIG. 9 is a flowchart illustrating a method for controller engagement detection, in accordance with some embodiments.

FIG. 10 is a block diagram of an example electronic device, in accordance with some embodiments.

### DETAILED DESCRIPTION

Headsets can provide an immersive experience. Many headsets provide a hand-held controller for controlling what is displayed. For example, a person can play a game with a controller. However, it can be desirable to enable a user to use its hands to control as well. It is further desirable to provide both options to a user in a user-friendly manner. Finally, determining whether the user is using a controller or hands can help conserve power instead of relying on the user to manually change the input/usage mode.

The techniques disclosed in the present disclosure can use image recognition software running on a headset (part of an extended reality (XR) environment) to seamlessly switch the input mode (hands or physical controller) by detecting when the user picks up a controller (or referred to as controller engagement detection). The disclosed techniques can include a controller-tracking model that can identify and track a controller by fusing video frames (or images) taken by the headset and motion data (e.g., measurements by inertial measurement unit (IMU)) obtained from the controller. Interpolation and prediction can also be performed.

The disclosed techniques can also include a hand-tracking model that can identify and track the user's hands in video frames (or images) taken by the headset to predict 3D poses of the hands and derive their geometric features. An action (e.g., touch) that the hands may have taken is determined.

The disclosed techniques can further include a handheld model for determining whether a user has picked up and is holding a controller. In some embodiments, a spatial relationship between the hands and the controller can be determined based on data provided by both the controller-tracking model and the hand-tracking model, and additional proximity (or touch) sensors on the controller. If a hand is within a proximity threshold of the controller, then the input mode for the headset can switch from hand mode to controller mode. The proximity threshold can be defined as being within a threshold distance of a particular part of the controller (e.g., near a handle of the controller).

In some embodiments, a geometry model may be used to perform the proximity threshold test, such as the controller and a hand are within a proximity region of a 3D environment. In some embodiments, the geometry model may perform a geometric check (e.g., shape and location of wrist joints) of a hand to determine whether the hand is holding a controller. Additionally, data from proximity and/or motion (e.g., inertial measurement units (IMU)) sensors in the controller can be used to increase the accuracy of the determination.

In other embodiments, the handheld model may be a machine learning (ML) model trained to determine whether a user has picked up and is holding a controller.

Embodiments of the present disclosure provide a number of advantages/benefits. For example, fusing both visual detection and motion data for the controller can not only accurately determine the controller's poses but also make predictions that can be in sync with the controller's real-time positions because the captured images of the controller may be slightly behind. Additionally, the handheld model that fuses the controller-tracking model, hand-tracking model, and information from proximity sensors can generate a better spatial relationship between the hands and the controller, resulting in a more accurate determination of whether a user is holding a controller.

### I. Headset Overview

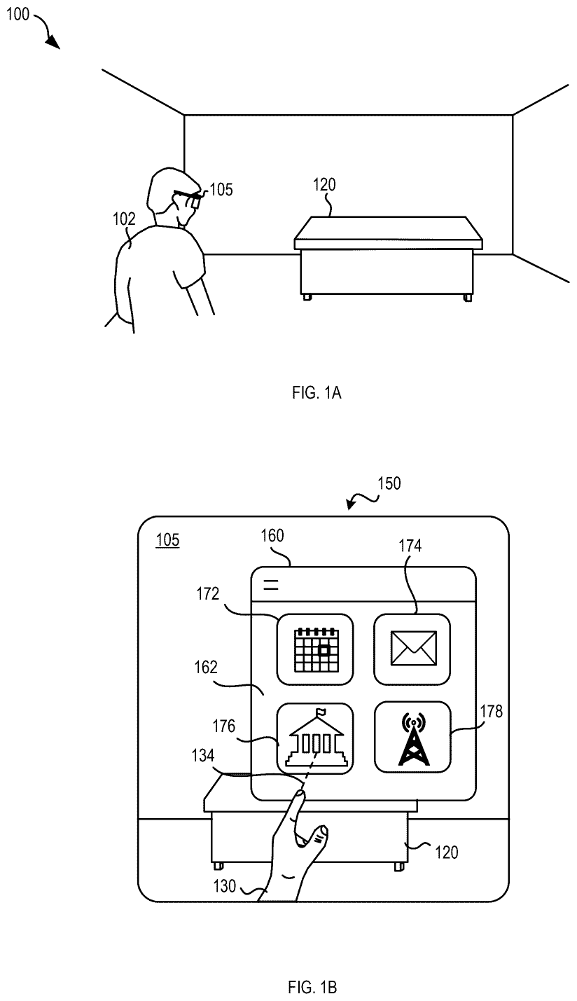

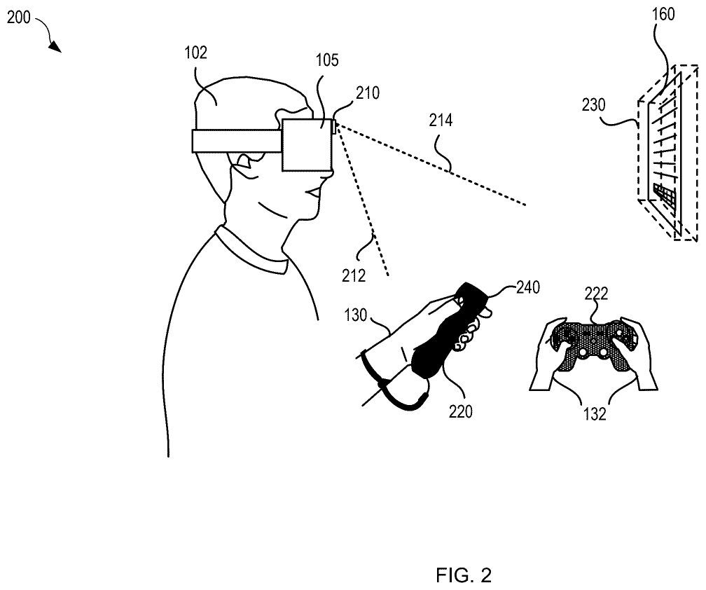

FIGS. 1A, 1B and 2 provide an overview of the functions of an example electronic device (e.g., a wearable device such as a head-mounted display (HMD) or a headset) and how a user can interact with the electronic device, for example, using hands or a controller.

FIG. 1A is a diagram illustrating an example electronic device operating in a physical environment, in accordance with some embodiments. The electronic device 105 (e.g., a headset) may include one or more cameras, microphones, depth sensors, or other sensors that can be used to capture information (e.g., images, sound, lighting characteristics, etc.) about and evaluate the physical environment 100 and the objects within it, as well as information about the user 102 of the electronic device 105. The information about the physical environment 100 and/or user 102 may be used to provide visual and audio content and/or to identify the current location of the physical environment 100 (e.g., including locations of objects, such as the desk 120, in the physical environment 100) and/or the location of the user within the physical environment 100.

In some implementations, views of an extended reality (XR) environment may be provided to one or more participants (e.g., user 102 and/or other participants not shown) via electronic devices 105 (e.g., headsets). XR may be an umbrella term that covers virtual reality (VR), augmented reality (AR), mixed reality (MR), and the like. Such an XR environment may include views of a 3D environment that are generated based on camera images and/or depth camera images of the physical environment 100, as well as a representation of user 102 based on camera images and/or depth camera images of the user 102. Such an XR environment may include virtual content that is positioned at 3D locations relative to a 3D coordinate system (i.e., a 3D space) associated with the XR environment, which may correspond to a 3D coordinate system of the physical environment 100.

FIG. 1B is a diagram illustrating a view, provided via an electronic device (e.g., a headset), of virtual elements within the 3D physical environment of FIG. 1A, in which a user can interact with the virtual elements using hands, in accordance with some embodiments.

In this example, the user 102 may use a hand to interact with the content presented in views 150 of an XR environment provided by electronic device 105. The views 150 of the XR environment include an exemplary user interface 160 of an application (e.g., an example of virtual content) and a depiction of the desk 120 (i.e., an example of real content). As an example, in FIG. 1B, the user interface 160 is a two-dimensional virtual object (e.g., having a flat front-facing surface). Providing such a view may involve determining 3D attributes of the physical environment 100 above (e.g., a position of the desk 120 in the physical environment 100, a size of the desk 120, a size of the physical environment 100, etc.) and positioning the virtual content, for example, user interface 160, in a 3D coordinate system corresponding to that physical environment 100. In the example of FIG. 1B, the user interface 160 includes various content items, including a background portion 162 and icons 172, 174, 176, 178. The icons 172, 174, 176, 178 may be displayed on the flat user interface 160. The user interface 160 may be a user interface of an application, as illustrated in this example. The user interface 160 is simplified for purposes of illustration and user interfaces in practice may include any degree of complexity, any number of content items, and/or combinations of 2D and/or 3D content. The user interface 160 may be provided by operating systems and/or applications of various types including, but not limited to, messaging applications, web browser applications, content viewing applications, content creation and editing applications, or any other applications that can display, present, or otherwise use visual and/or audio content.

FIG. 2 is a diagram illustrating an interaction between a user and the virtual elements of FIG. 1B, provided via an electronic device (e.g., a wearable device such as a headset), using one or more objects (e.g., a controller), in accordance with some embodiments. In this example, the user 102 may view and interact with an XR environment that includes the user interface 160 by using hands 130 and 132, or a controller 220 or 222. A 3D area 230 around the user interface 160 is determined by the electronic device 105. Note that, in this example, the dashed lines indicating the boundaries of the 3D area 230 are for illustration purposes and are not visible to the user 102.

The controller may be a gaming controller 222 or a motion controller 220. A motion controller 220 may include, but not limited to, motion sensors, proximity sensors, light-emitting diodes 240 (LEDs arranged in, e.g., an array or a circle), or the like, to help track the movement (e.g., position and orientation) of the controller 220. The electronic device 105 may also have one or more cameras 210 with image sensors to capture, via 212 and 214, images of the hands 130 and 132, and controllers 220 and 222 for tracking purposes. In some embodiments, the controller 220 or 222 may pair and communicate with the electronic device 105 (e.g., headset) via Bluetooth. When using the controller 220 or 222 to play games, the controller 220 or 222 may additionally pair and communicate with a gaming counsel (not shown).

A headset capable of generating XR environment for user interaction discussed above may have many potential benefits and applications, including, but not limited to, entertainment and gaming, training and education, indoor and outdoor navigation, health care and medical applications, etc.

The headset may include circuitry and/or software that, when executed, implement a machine learning model. A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

### II. Controller-Tracking Model

A headset (e.g., 105) may use one or more hand-held controllers (e.g., 220 or 222) to control what is displayed, such as playing games. A controller-tracking model can identify and track each controller by fusing images taken by the headset with motion data obtained from the controller. A controller-tracking model may include sub-models (described below) that use various techniques, such as visual detection (e.g., image processing and computer vision), motion detection, machine learning models, etc.

The controller-tracking model can be a machine learning model that is trained to use images for detecting and tracking a controller. The controller-tracking model can be trained for a particular controller. A set of training images (e.g., real, synthetic, or augmented images) can be generated or captured with the controller labeled (e.g., pixels corresponding to the controller) in the images (or video frames). Such training images can include other objects, such as hands, other types of controllers, phones, etc. In some implementations, the model can determine the probability a pixel is part of the controller. If a sufficient number of pixels have a probability greater than a threshold, then those pixels can be identified as corresponding to the controller.

### A. Controller-Tracking Sensors

Typically, a controller (e.g., video game controller) may be used to interact with the 3D display from the headset (or XR system). In some embodiments, two controllers (i.e., dual controller) may be used, such as motion controllers for tacking a game player's motion: a left controller for the left hand and a right controller for the right hand.

Tracking a controller may utilize various sensors of the headset, of the controller, or both. Example sensors include image sensors, depth sensors, or other sensors embedded in cameras mounted on the headset and motion sensors in the controller. In certain embodiments, the motion sensors may include an inertial measurement unit (IMU), a three-dimensional accelerometer, a three-dimensional gyroscope, or the like, that may detect the motion of the user equipment (e.g., the controller). For example, the IMU may detect a rotational movement of the user equipment, an angular displacement of the user equipment, a tilt of the user equipment, an orientation of the user equipment, a linear motion of the user equipment, a non-linear motion of the user equipment, or the like.

The controller-tracking model (also referred to as controller tracker) may involve performing visual detection (e.g., using image sensors) and incorporating motion data (e.g., measurements by motion sensors, such as inertial measurement units (or inertial sensors)). The visual detection result and motion data (e.g., inertial measurements) can be combined or fused together to estimate the controller's pose (or spatial pose in three or six dimensions including the three rotational angles) and make predictions of future poses.

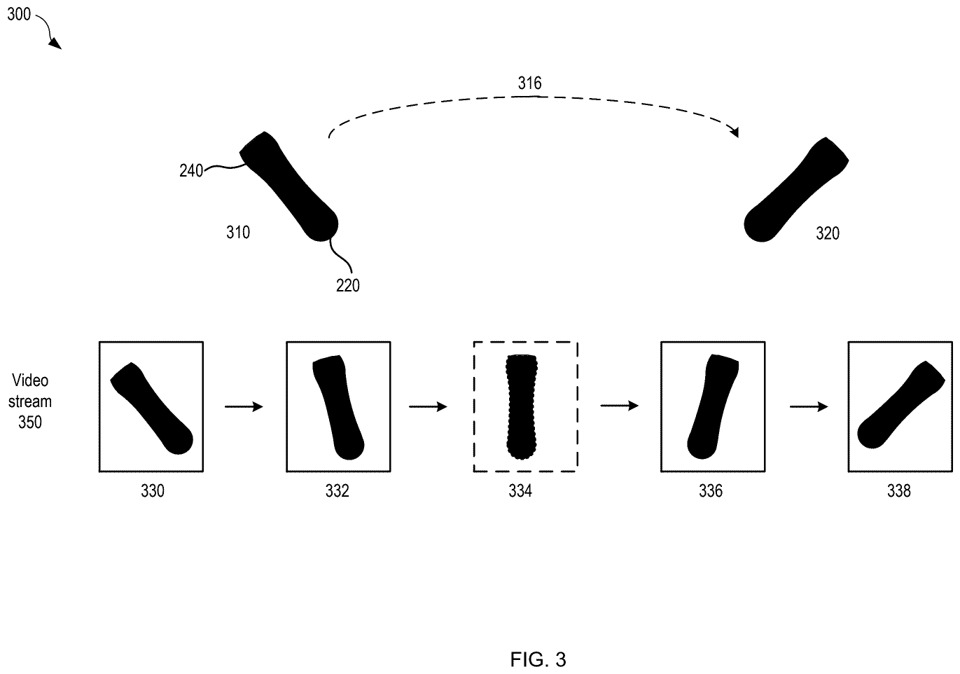

FIG. 3 is a diagram illustrating an example controller-tracking model using images and motion data, in accordance with some embodiments. In FIG. 3, the controller 220 may move from position 310 to position 320 through a trajectory 316 (including rotation), which may be recorded as motion data by the motion sensors of the controller. Video stream 350 captured by video camera 210 may include a set of frames 330-338. Sometimes, the controller 220 may be obscured or blocked, and become invisible or unclear in one or more frames, such as frame 334.

When a controller is paired with the headset, the information about the controller (e.g., models, shapes, features, location of LEDs, etc.) can be communicated to the headset, which can start looking for the controller. In some implementations, the headset can be configured to look for and track specific types of controllers. In some embodiments, if multiple controllers (including the dual controller case) are used, each controller may be paired separately. Each controller may be a different model. Once a controller is initially paired (e.g., exchange security credentials to establish a secured connection) with the headset, the same controller can be automatically connected to the headset when it is picked up by a headset user or disconnected when it leaves the user's hands.

### 1. Visual Detection

In FIG. 3, for visual detection, the controller tracker may capture a video stream of the controller to find particular frames 330-338 that have 2D images of the controller. The LEDs 240 of the controller may also be identified to estimate the spatial pose (position/location and orientation) of the controller in 3D space. In some embodiments, a machine learning (ML) model may be trained to recognize various types of controllers based on the 2D images of the controller according to the information about the controller. The ML model may include one or more convolutional layers of a convolutional neural network (CNN), and related architectures. Those skilled in the art will appreciate various ways and techniques that can be used to perform pattern recognition of a controller. The techniques may include, but not limited to, EfficientNet, inception neural network, residual neural network (Resnet), and the like.

In certain embodiments, visual detection may utilize an ML model to detect LEDs 240 on the controller 220, and then estimate its pose. This ML model for detecting LEDs 240 may be the same ML model for recognizing a controller (discussed above) or a different ML model (i.e., two sub-models of the controller-tracking model). After identifying the frames 330, 332, 336, and 338 that contain the images of the controller 220, the ML model may create a 3D representation of the controller by detecting the LEDs 240 on the controller 220, and then estimate the controller's pose. For example, a controller may have twelve LEDs arranged in a particular pattern (e.g., a circle, an arc, or a triangle) in different colors (or infrared light) from number 1 to number 12. In some embodiments, more (e.g., 18 LEDs) or fewer LEDs (e.g., 6 LEDs) may be used as long as they can serve the purpose of estimating the controller's pose. 2D keypoints (e.g., corners and edges of the controller) may be identified so that the model can follow the controller's movement. The corresponding 3D keypoints (e.g., position and orientation) can also be identified by detecting a few illuminated LEDs (e.g., number 1, number 7, and number 12 in different colors). The change of spatial relationship among these illuminated LEDs may provide information about the position/location and orientation of the controller. In some embodiments, various algorithms/techniques for object tracking may be used to estimate the controller's pose. Additionally, various algorithms/techniques can be used to detect and eliminate outliers of the captured frames to improve model fitting. In other words, the 3D position of the LEDs in a coordinate frame is identified.

When training the ML model for detecting LEDs, 3D animation of the controller 220 and the illuminated LEDs may be used as a set of training datapoints or training samples (also referred to as a training dataset). Each training datapoint may include video frames of the controller and illuminated LEDs in various positions and orientations, and ground truth (annotated/labeled data, e.g., corresponding known positions and orientations of the controller). In various embodiments, these video frames may be real data (e.g., video stream taken by a video camera), synthetic data (e.g., simulation or sampled data), or augmented data (e.g., transformations to existing data). The ML model may be trained by comparing the known positions and orientation to its predicted output. The parameters of the ML model can be iteratively varied to increase accuracy.

In some embodiments, two controllers may be used, such as a left-hand controller and a right-hand controller. In such a scenario, an ML model may be used to identify a particular type of controller that has a pair of controllers for use (referred to as dual controller case) from the video frames 330-338. Then, another two ML models, one for the left-hand controller and another for the right-hand controller, are trained to detect LEDs 240 on each controller, respectively.

In certain embodiments, a rolling shutter technique may also be used to identify the LEDs 240 to estimate the controller's pose. The LED lights on the controller 220 may strobe constantly. The shutter of the camera 210 may be exposed for a small period of time to synchronize with the LED strobes, such that the LED lights are clear (not blurred due to motion) and can stay on all the time for the camera 210. Accordingly, the controller tracker can determine the controller's positions over time. In certain embodiments, the rolling shutter technique can be used together with motion data (discussed below). In other embodiments, the rolling shutter technique may be used to supplement insufficient motion data when the Bluetooth bandwidth is shared among multiple devices and is insufficient for transferring the motion data.

### 2. Motion Data

In some embodiments, motion data 316 (e.g., measurements by motion sensors, such as inertial measurement unit (IMU)) of the controller 220 moving from position 310 to 320 may be provided (e.g., through Bluetooth) to the headset to help determine the position of the controller. The position may be expressed using six degrees of freedom (6DoF) of the controller, such as its 3D position (e.g., x, y, and Z axes) and 3D orientation (e.g., related to rotation such as pitch, yaw, and roll). For example, in FIG. 3, the frames 330-338 captured by video camera 210 may not have adequate frame rate or may not collect all positions of the controller (e.g., due to blocking by other objects). The motion data 316 may be combined or fused with the video stream 350 to help enhance trajectory estimation and optimization, such as using the factor graph least squares smoother technique.

In this example, the controller may be missing a frame 334. The controller may start with position 310 (or captured as a frame 330 in a video stream 350) and end up in position 320. The video camera may be able to capture the movement of the controller 220 in a few frames, 330, 332, 336, and 338. However, the controller may be obstructed by another object during the moving, such that the controller is missing in one of the frames, frame 334. Using the motion data 316, the controller tracker can interpolate (or approximate) and reconstruct the position of the controller 220 in the frame 334 based on frame 332 (controller's historical position), frame 336, and motion data 316.

In some embodiments, the motion data 316 can be used to predict (or extrapolate) where the controller 220 may go and its future position based on historical visual information. This prediction may be useful because an image the video camera 210 captures may be slightly behind (e.g., roughly 40 milliseconds) the controller's actual (or real-time) positions. The controller tracker can take previous motion estimates and historical positions to predict future positions, such that the prediction can line up with the controller's actual movement.

### B. Data Estimation—Prediction and Interpolation

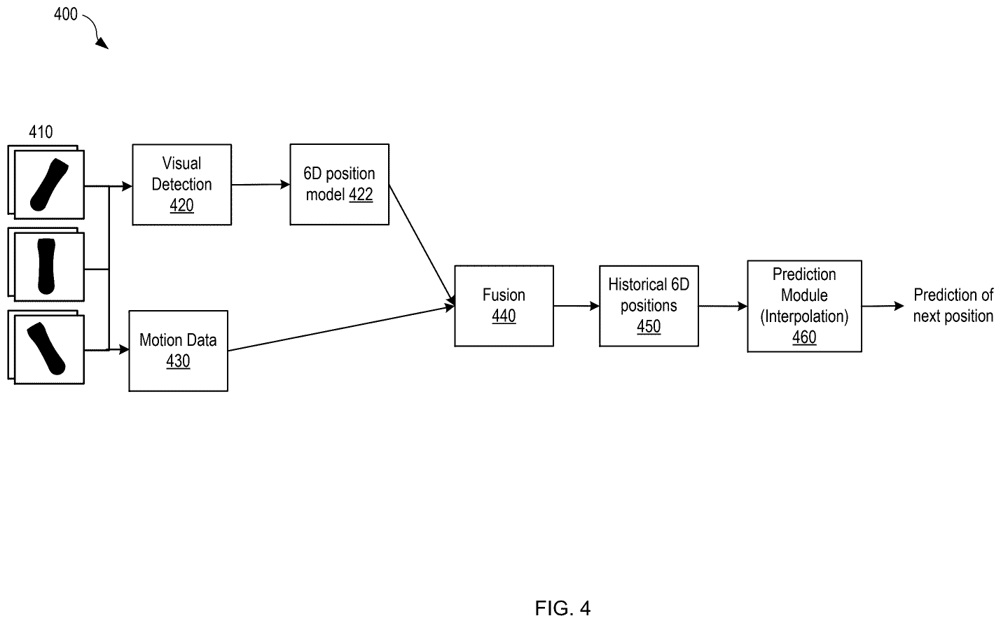

FIG. 4 illustrates a flow diagram of an example controller-tracking model, in accordance with some embodiments. The controller-tracking model 400 begins with a set of frames 410 (or video stream) and motion data 430. As discussed above, the frames may be a temporal series of image frames of the controller 220 captured by one or more cameras 210. The frames may include 2D images of the controller 220 and LEDs 240. The set of frames 410 may be applied to a visual detection model 420. As discussed above, the visual detection model 420 may recognize various types of controllers based on the images of the controller. The visual detection model 420 can identify a few illuminated LEDs in different locations of the controller and pass the information to a 6D position model 422, which may be a ML model that is trained to estimate the controller's 6DoF pose. For example, multiple LEDs on the controller may be arranged in a particular pattern and/or with different colors. By identifying a few particular LEDs (e.g., numbers 1, 5, 8) and their relative locations across various frames, the controller's 6DoF pose (i.e., 3D position and 3D orientation) 422 may be determined. In some embodiments, the visual detection model 420 and the 6D position model 422 may be combined.

The motion data 430 (e.g., displacement, rotation, and acceleration) collected/measured by the motion sensors of the controller 220 may also be provided to the controller-tracking model. A fusion network 440 may be configured to receive as input, the motion data 430 and the estimated 6D pose 422 of the controller from the visual detection model 420, and construct a smooth and more complete historical 6D positions of the controller 220. In some embodiments, the motion data 430 and the estimated 6D positions from 6D position model 422 may be weighted in combination in different ways by the fusion network 440. Based on these historical positions 450, the controller's pose can be interpolated. The controller's next pose may also be predicted (e.g., extrapolated, or approximated) by the prediction module 460 using the motion data 430, assuming the same movement of the controller continues.

In some embodiments, exact positions (e.g., interpolation or extrapolation) of the controller 220 at a particular time may be generated based on, for example, the velocity and angles of the moving path. In other embodiments, approximated positions of the controller 220 at a particular time may be generated, for example, using Cubic Splines or polynomials. Depending on the applications, interpolation/extrapolation and approximation may be used at different times. For example, interpolation/extrapolation may be used when the user engages in a localized activity or slower motion. Approximation may be used when the user engages in more rigorous activity or faster motion, such as aerobics.

As an illustration of interpolation and prediction, in FIG. 3, the missing controller pose in frame 344 can be interpolated based on frame 332 (the controller's historical position), frame 336, and motion data 316. Additionally, if the last captured frame is 336 and the controller's movement is assumed to be the same, then the controller's position in frame 338 may be predicted.

In some embodiments, interpolation, approximation, and prediction may also be performed using two or more 6D positions using 6D positions model 422 of the controller 220 from the visual detection model 420 without motion data 316. For example, an average can be calculated based on frame 332 (the controller's historical position or a first image) and frame 336 (e.g., a second image) to obtain an interpolation (or approximation) resulting in frame 344 (e.g., a third image). Additionally, the controller-tracking model may be able to predict the next frame by identifying the changing pattern of frames 336 (e.g., a first image) and 338 (e.g., a second image) and then applying the changing pattern to frame 338 to generate the next frame (e.g., a third image). If the motion data 316 is available, the calculated average for interpolation or prediction may be refined or adjusted accordingly.

### III. Hand-Tracking Model

A hand-tracking model of the XR system (or a headset) may use hand-tracking data to perform a hand-tracking algorithm to track the positions, pose (e.g., position/location and orientation), configuration (e.g., shape), or other aspects of the hand over time. A hand-tracking model may include sub-models that use various techniques, such as image processing, computer vision, ML models, etc. The hand-tracking model may be an ML model (e.g., a neural network) that is trained to estimate the physical state of a user's hand or hands. The hand-tracking data may include, for example, image data, depth data (e.g., information about the distance from a camera), etc. Accordingly, the hand tracking data may include or be based on sensor data, such as image data and/or depth data captured of a user's hand or hands. In some embodiments, the sensor data may be captured from sensors on an electronic device, such as outward facing cameras on a head mounted device, or cameras otherwise configured in an electronic device to capture sensor data including a user's hands.

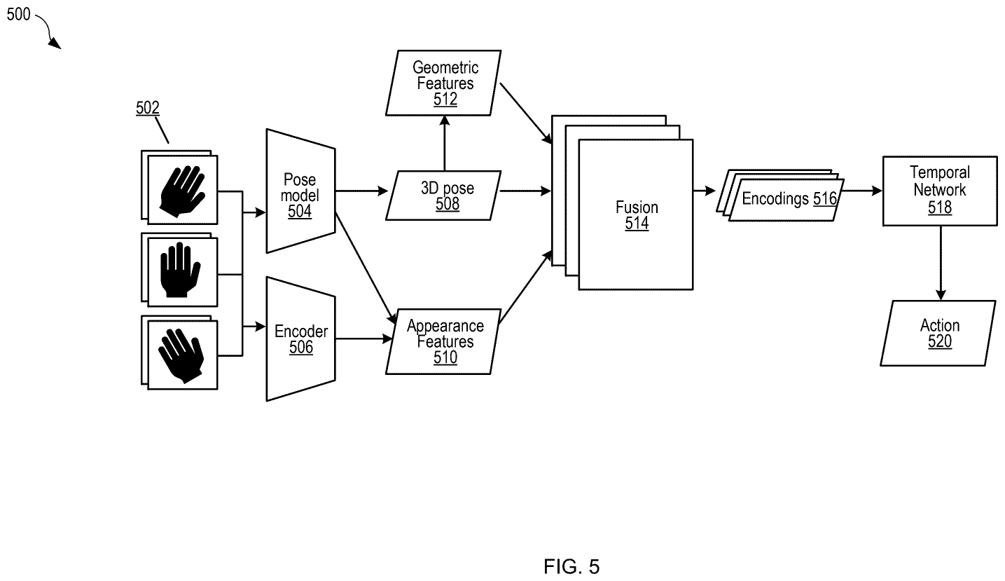

FIG. 5 is a flow diagram illustrating an example hand-tracking model, in accordance with some embodiments. The hand-tracking model 500 begins with a set of frames 502 as input. The frames 502 may be a temporal series of image frames of a hand captured by one or more cameras. The cameras may be individual cameras, stereo cameras, cameras for which the camera exposures have been synchronized, or a combination thereof. The cameras may be situated on a user's electronic device, such as a mobile device or a head mounted device (e.g., electronic device 105). The frames may include a series of one or more frames associated with a predetermined time. For example, the frames 502 may include a series of individual frames captured at consecutive times, or can include multiple frames captured at each of the consecutive times. The entirety of the frames may represent a motion sequence of a hand from which a touch may be detected or not for any particular time.

The frames 502 may be applied to a pose model 504. The pose model 504 may be a trained ML model (e.g., neural networks) configured to predict a 3D pose 508 of a hand based on a given frame (or set of frames, for example, in the case of a stereoscopic camera) for a given time. That is, each frame of frame set 502 may be applied to pose model 504 to generate a 3D pose 508. As such, the pose model can predict the pose of a hand at a particular point in time. In some embodiments, geometric features 512 may be derived from the 3D pose 508. The geometric features may indicate relational features among the joints of the hand, which may be identified by the 3D pose. That is, in some embodiments, the 3D pose 508 may indicate the position and location of joints in the hand, whereas the geometric features 512 may indicate the spatial relationship between the joints. As an example, the geometric features 512 may indicate a distance between two joints, etc.

In some embodiments, the frames 502 may additionally be applied to an encoder 506, which is trained to generate latent values for a given input frame (or frames) from a particular time indicative of an appearance of the hand. The appearance features 510 may be features which can be identifiable from the frames 502, but not particularly useful for pose. As such, these appearance features may be overlooked by the pose model 504, but may be useful within the hand-tracking model 500 to determine whether a touch occurs. For example, the appearance features 510 may be complementary features to the geometric features 512 or 3D pose 508 to further the goal of determining a particular action 520, such as whether a touch has occurred. According to some embodiments, the encoder 506 may be part of a network that is related to the pose model 504, such that the encoder may use some of the pose data for predicting appearance features. Further, in some embodiments, the 3D pose 508 and the appearance features 510 may be predicted by a single model, or two separate, unrelated models. The result of the encoder 506 may be a set of appearance features 510, for example, in the form of a set of latents.

A fusion network 514 may be configured to receive as input, the geometric features 512, 3D pose 508, and appearance features 510, and generate, per time, a set of encodings 516. The fusion network 514 may combine the geometric features 512, 3D pose 508, and appearance features 510 in any number of ways. For example, the various features can be weighted in combination in different ways or otherwise combined in different ways to obtain a set of encodings 516 per time.

The encodings are then run through a temporal network 518, to determine an action 520 per time. The action 520 may indicate, for example, whether a touch, or change in touch stage has occurred or not. The temporal network 518 may consider both a frame (or set of frames) for a particular time for which the action 520 is determined, as well as other frame in the frame set 502.

### IV. Handheld Model for Determining when a User Picks Up A Controller

To determine whether a user has picked up a controller 220, a spatial relationship between the hands and the controller may be determined. The controller-tracking model 400 described in FIG. 4 and the hand-tracking model 500 described in FIG. 5 can be utilized. Additionally, proximity sensors in the controller 220 can be used to increase the accuracy of determination. A proximity sensor may be capable of detecting the presence or absence of a nearby object without physical contact, and include, but not limited to capacitive sensor, inductive sensors, magnetic sensor, and the like.

When determining the spatial relationship between the hands and the controller, a proximity threshold may be defined. If a hand is within a proximity threshold of the controller, then the input mode of the headset (e.g., electronic device 105) can switch from hand to using the controller. Various approaches may be used to establish the proximity threshold and determine whether the user has picked up the controller, such as geometric check, physical check (e.g., based on velocity and vectors). Additionally, a machine learning (ML) model may also be trained to determine whether a user has picked up and is holding a controller.

### A. Handheld Model—Geometric Check and Physical Check

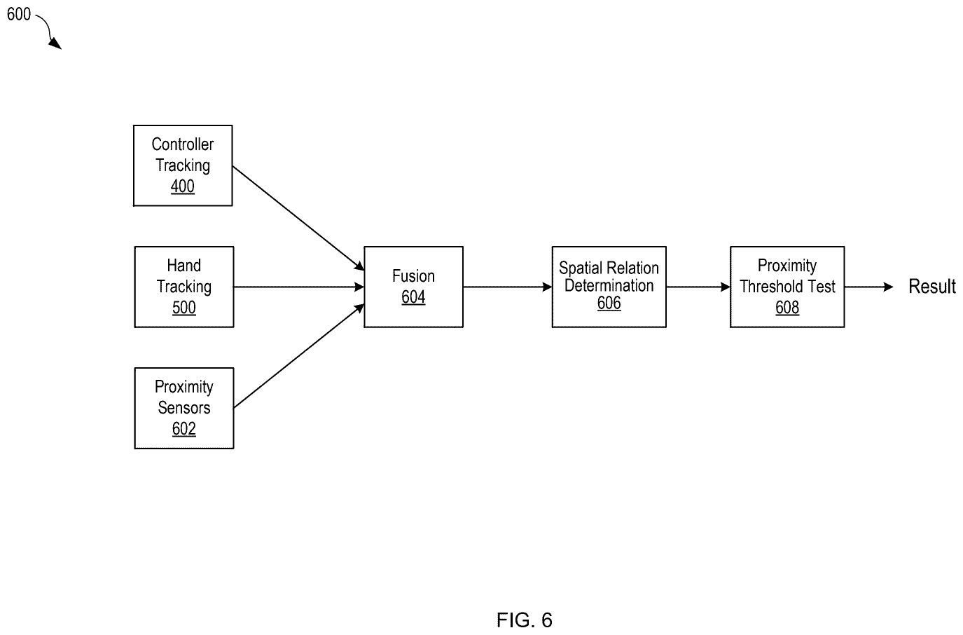

A handheld model (FIG. 6) may have several pipeline stages, and one of the stages, the proximity threshold test, may include either a geometric check or a physical check.

FIG. 6 is a flow diagram illustrating an example architecture of a handheld model for determining whether a user is holding a controller (i.e., handheld model), in accordance with some embodiments. In FIG. 6, the handheld pipeline 600 may begin with a controller-tracking model 400, hand-tracking model 500, and proximity sensors. The controller-tracking model 400 can provide information about the controller's pose and location. The hand-tracking model 500 may provide information about the user's hand pose and location. The proximity sensor may provide information about the closeness of the user's hands to the controller based on the changes in certain characteristics (e.g., capacitance for capacitive sensors, electromagnetic field for inductive sensors or magnetic fields for magnetic sensors).

A fusion network 604 may be configured to receive information from the controller-tracking model 400, hand-tracking model 500, and proximity sensors as inputs and generate a 3D spatial (and temporal) relation 606 between the user's hands and the controller. For example, a user's hand may move in the direction (e.g., by hand-tracking) toward the controller, and slow down gradually (e.g., moving speed). The user's hand is close (in distance) to the controller and surrounds the contour of the controller (e.g., by controller-tracking and proximity sensors). As a further example, the hand and the controller are moving in the same direction and speed could indicate they are likely to be together. The same movement between the two would not occur if the hand drops or lets go of the controller.

A proximity threshold test 608 may be applied to determine whether the user has picked up and holding the controller. In some embodiments, a geometric model may be used. For example, in the geometry mode, the proximity threshold can be defined as being within a threshold distance of a particular part (or region) of the controller (e.g., near a handle of the controller). A pose (position and orientation) of the controller and the pose of the hands can be determined and placed in a 3D environment to check if both are in the proximity region of the environment, such as similar poses for the controller and the touching hand, and close in distance.

In some embodiments, the geometric model may involve checking the pose (or geometry) of a hand in the captured images. Because a controller of different types may be held by a hand in a few ways, the geometry model may determine whether the controller has been picked up and held in the hand. For example, when holding a controller, the wrist joint may be in a particular spot due to the sphere in the controller frame. By examining the shape of certain parts of hands based on the hand-tracking information, whether a hand is holding a controller can be determined. For example, some embodiments can distinguish whether a hand holding the controller is the user's hand or a non-user's hand by analyzing movement history of the hand holding the controller.

In other embodiments, a physical check may be used. For example, a gyro angular velocity threshold (e.g., based on gyro reading from motion data) can be applied because a controller may be placed on a flat surface (e.g., a table) in a limited number of ways (or configurations). In those configurations, the gravity vector may be observed because the gravity vector may point in a few directions depending on whether a controller is held or not.

Once the proximity threshold test is passed and it is determined that the user is holding the controller with its hand (e.g., by way of visual hand pose determination and/or motion sensor data from the controller), the headset may switch its input mode from hand mode to controller mode. Each one of the techniques (e.g., controller and hand tracking, proximity sensors, geometric checks, and physical checks) may be useful to certain degrees. However, combining these techniques can lead to a better and more accurate determination.

Furthermore, in a dual controller case, the handheld model may also be configured to determine which hand is holding which controller and switch to controller input mode for a particular controller when the handheld model has detected the correct hand has engaged with the corresponding controller (e.g., the right hand has engaged with the controller for the right hand). For example, if the handheld model detects the left hand is holding the right-hand controller, the controller input mode may not be switched for the right-hand controller. In some embodiments, the determination of the correct hand holding the correct controller may use visual detection of the hand-tracking model and controller-tracking model. In other embodiments, visual detection and motion data can be fused together to perform the determination. For example, the hand-controller model may detect the right hand moving toward a controller within a proximity threshold, and the controller-tracking model also detects the movement of the right controller (e.g., by IMU of the right controller).

In further embodiments, the handheld model may also be configured to determine whether the hand engaging the controller is the user's hand as opposed to a non-user's (or another person's) hand, and switch the controller input mode accordingly. For example, the hand-tracking model may determine where a hand engaging a controller comes from. Since a user's hand typically is within a certain range (or a threshold range) from the headset, a hand appearing from outside the range is less likely to be the user's hand. Distinguishing the user's hand or another person's hand may involve checking the movement history of a hand to identify where the hand originates.

### B. Handheld Model-Machine Learning

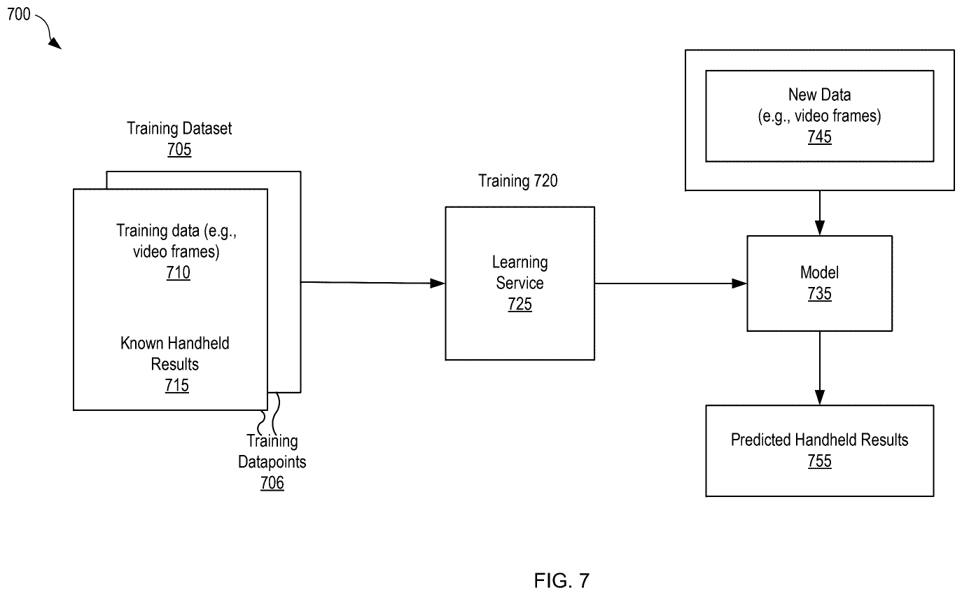

FIG. 7 illustrates an example architecture for training a machine learning model to determine whether a user is holding a controller in accordance with some embodiments. In FIG. 7, a training dataset 705 comprises multiple training datapoints 706. Each training datapoint 706 may include training data 710, such as video frames containing both a controller and the user's hands, and corresponding known handheld results 715 (or called ground truth). The known handheld results 715 may include an indication of whether a particular video frame shows a controller is being touched, held by a hand, or within a proximity threshold region defining a held controller. In certain embodiments, an additional indication of whether a left-hand controller or a right-hand controller has been picked up by a corresponding hand (i.e., left hand or right hand) as in the dual-controller scenario discussed above.

The training datapoint 706 can be used by a learning service 725 to perform training 720. A service, such as learning service 725, is one or more computing devices configured to execute computer code to perform one or more operations that make up the service. Learning service 725 can optimize parameters of a model 735 such that a quality metric (e.g., accuracy of model 735) is achieved with one or more specified criteria. The accuracy may be measured by comparing known handheld results 715 to predicted handheld results. Parameters of model 735 can be iteratively varied to increase accuracy. Determining a quality metric can be implemented for any arbitrary function, including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 730 can provide a predicted handheld result 755 for new data 745. The predicted handheld result 755 can be a predicted determination of whether a controller is held by a hand corresponding to the new data 745 (e.g., a video frame). The new data can be of a similar type as training data 710. If new data is of a different type, a transformation can be performed on the data to obtain data in a similar format as training data 710.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

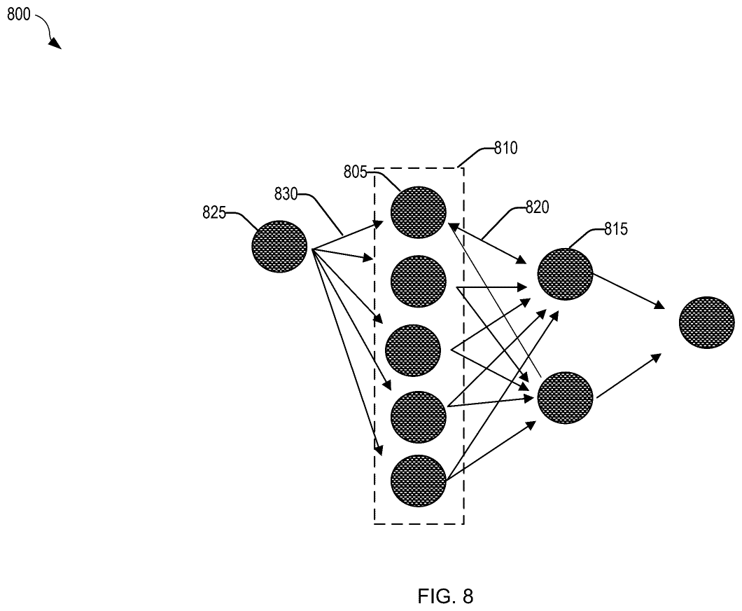

FIG. 8 illustrates an example machine learning model of a neural network, in accordance with some embodiments. As an example, model 800 can be a neural network that comprises a number of neurons (e.g., Adaptive basis functions) organized in layers. For example, neuron 805 can be part of layer 810. The neurons can be connected by edges between neurons. For example, neuron 805 can be connected to neuron 815 by edge 820. A neuron can be connected to any number of different neurons in any number of layers. For instance, neuron 805 can be connected to neuron 825 by edge 830 in addition to being connected to neuron 815.

The training of the neural network can iteratively search for the best configuration of the parameter of the neural network for feature recognition and prediction performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information.

### V. Method for Managing Input Mode of a Headset Device

After determining that the controller (e.g., controller 220) has been picked up by a user (e.g., user 102), the headset may switch its input mode from a hand mode (i.e., using hands) to a controller mode (i.e., using a controller). After the switching, the headset (e.g., electronic device 105) may stop tracking hands or reduce the frequency of tracking hands using the hand-tracking model (e.g., capturing images of the hands by one or more cameras at a lower frame rate) to conserve computing power. In some embodiments, as discussed above for the dual-controller case, input mode may be switched after the correct controller has been picked by the correct hand (e.g., left hand for a left-hand controller and right hand for a right-hand controller). In controller mode, signals (e.g., when pressing buttons) from the controller may be communicated through BT after the controller has paired with the headset. For example, a user may like to use the controller to interact with a user interface (e.g., user interface 160) of an application in the XR environment generated by the headset, such as playing games.

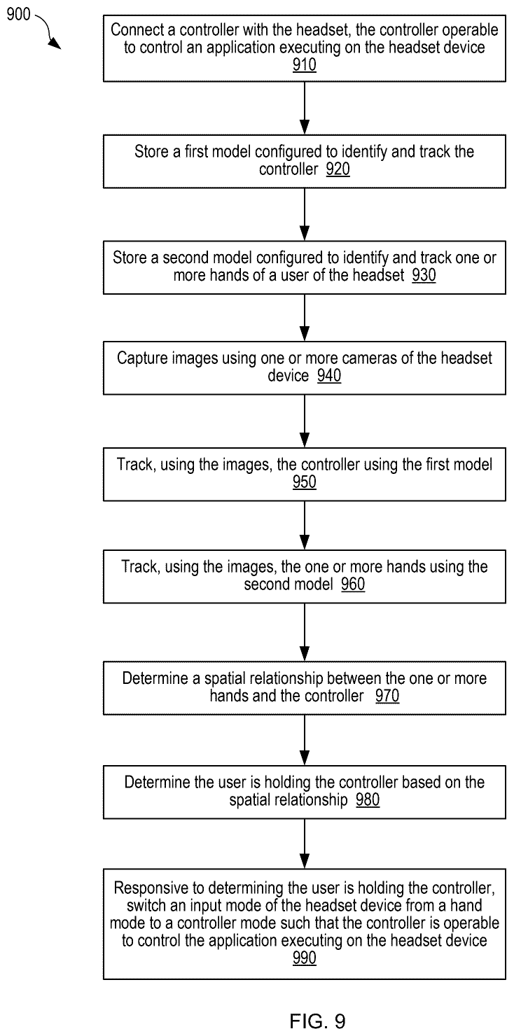

FIG. 9 is a flowchart illustrating a method for controller engagement detection, in accordance with some embodiments. The processing depicted in FIG. 9 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 9 and described below is intended to be illustrative and non-limiting. Although FIG. 9 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 9 may include a greater number or a lesser number of steps than those depicted in FIG. 9.

At block 910, a controller is connected with a headset device, where the controller is operable to control an application executing on the headset device. The controller can be connected after a pairing had previously been or recently done. For example, as in FIG. 2, a controller may be connected with a headset device. The controller may be able to interact with a user interface of an application in the XR environment generated by the headset device. When the controller is connected with the headset device (e.g., via Bluetooth), the information about the controller (e.g., models, shapes, features, location of LEDs, etc.) can be communicated to the headset, which can start looking for the controller. In some embodiments, individual controller (e.g., a right-hand controller or a left-hand controller) can be connected with electronic device 105 separately.

At block 920, a first model configured to identify and track the controller is stored. For example, a controller-tracking model (e.g., controller-tracking model 400) may be stored in a memory (or database) associated with the headset device. In some embodiments, the controller-tracking model (the first model) may be pre-installed in the headset device. The controller-tracking model may utilize various sensors (e.g., image sensors of one or more cameras and motion sensors) for capturing video streams (or images) and collecting motion data of the controller.

At block 930, a second model configured to identify and track one or more hands of a user of the headset is stored. For example, a hand-tracking model (e.g., hand-tracking model 500) may be stored in the memory (or database) associated with the headset device. In some embodiments, the hand-tracking model (the second model) may be pre-installed in the headset device. The hand-tracking model may also use one or more cameras to capture video streams (or images) of a user's hands.

At block 940, images are captured using one or more cameras of the headset device. For example, in FIG. 3, a set of frames (or images), e.g., frames 330-338, may be captured by one or more cameras (e.g., one or more cameras 210) of the headset device. Each frame (or image) may include a particular pose of the controller in motion (e.g., moving from position 310 to position 320) at a particular point in time.

At block 950, the controller is tracked by using a first model based on the images. The first model may be a controller-tracking model that is stored in a memory (or database) associated with the headset device. In some embodiments, the controller-tracking model may be pre-installed in the headset device. For example, the controller-tracking model may utilize various sensors (e.g., image sensors of one or more cameras and motion sensors) for capturing video streams (or images) and collecting motion data of the controller. The set of frames (or images) may be received as input by a visual detection model (e.g., visual detection model 420) of the controller-tracking model to estimate the controller's 6DoF pose. Additional motion data (e.g., motion data 430) received by the controller-tracking model may be fused with the visual detection result to generate prediction or interpolation of the controller's pose.

At block 960, the one or more hands are tracked by using by a second model based on the images. The second model may be a hand-tracking model that is stored in the memory (or database) associated with the headset device. In some embodiments, the hand-tracking model may be pre-installed in the headset device. The hand-tracking model may use one or more cameras to capture video streams (or images) of a user's hands. For example, in FIG. 5, video streams (or images, e.g., frames 502) of one or more hands of the user may be received as input by the hand-tracking model to identify the 3D pose (e.g., 3D pose 508) of the one or more hands, and determine an action (e.g., action 520) that the user is taking.

At block 970, a spatial relationship between the one or more hands and the controller is determined. For example, in FIG. 6, a handheld model may be used by fusing the controller-tracking model, the hand-tracking model, and additionally data from proximity sensors (e.g., proximity sensors 620) of the controller to determine spatial relationship between the one or more hands and the controller.

At block 980, whether the user is holding the controller is determined based on the spatial relationship. For example, as in FIG. 6, a proximity threshold test 608 (e.g., proximity threshold test) of the handheld model can be applied by using a geometric check (e.g., the shape of a holding hand), or a physical check (e.g., based on velocity and vectors), or a combination of both to determine whether the user is holding the controller. In some embodiments, an ML model (e.g., ML model 7000 may be trained by using the captured video frames containing both a controller and the user's hands to determine whether the user is holding the controller.

At block 990, responsive to determining the user is holding the controller, an input mode of the headset device is switched from a hand mode to a controller mode such that the controller is operable to control the application executing on the headset device. After determining that the controller has been picked up by a user, the headset may switch its input mode from a hand mode to a controller mode. As a result, the headset device may be configured to receive signals from the controller instead of tracking the one or more hands, such that the user can use the controller to interact with the user interface of an application in the XR environment generated by the headset device.

### VI. Use of Artificial Intelligence

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provider transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

### VII. Example Device

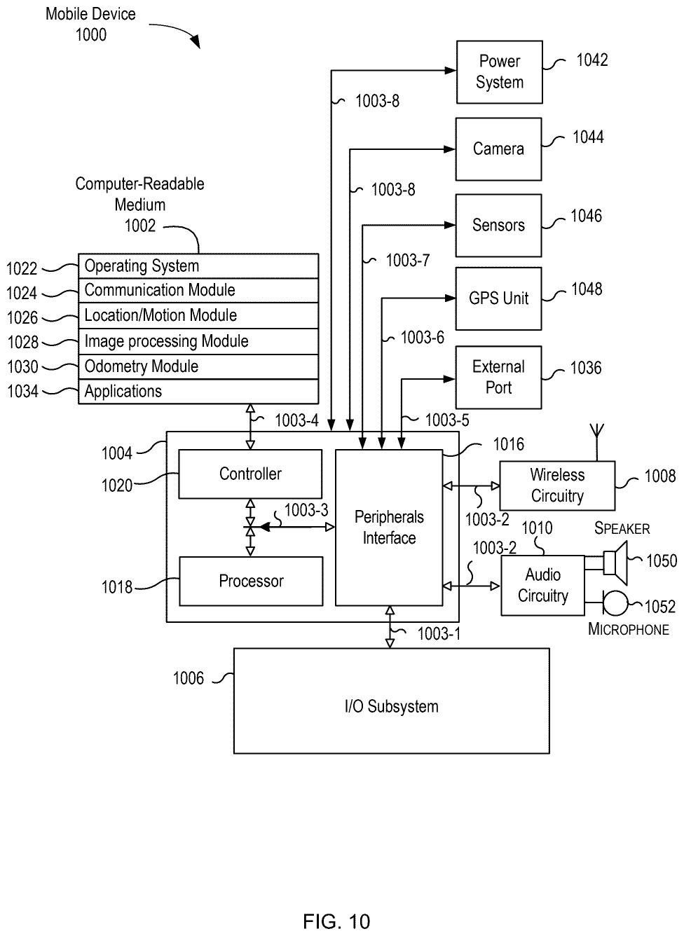

FIG. 10 is a block diagram of an example device 1000, which may be a mobile device. Device 1000 generally includes computer-readable medium 1002, a processing system 1004, an Input/Output (I/O) subsystem 1006, wireless circuitry 1008, and audio circuitry 1010 including speaker 1050 and microphone 1052. These components may be coupled by one or more communication buses or signal lines 1003. Device 1000 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 10 is only one example of an architecture for device 1000, and that device 1000 can have more or fewer components than shown, or a different configuration of components. The various components shown in FIG. 10 can be implemented in hardware, software, or a combination of both hardware and software, including one or more signal processing and/or application specific integrated circuits.

Wireless circuitry 1008 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1008 can use various protocols, e.g., as described herein.

Wireless circuitry 1008 is coupled to processing system 1004 via peripherals interface 1016. Interface 1016 can include conventional components for establishing and maintaining communication between peripherals and processing system 1004. Voice and data information received by wireless circuitry 1008 (e.g., in speech recognition or voice command applications) is sent to one or more processors 1018 via peripherals interface 1016. One or more processors 1018 are configurable to process various data formats for one or more application programs 1034 stored on medium 1002.

Peripherals interface 1016 couple the input and output peripherals of the device to processor 1018 and computer-readable medium 1002. One or more processors 1018 communicate with computer-readable medium 1002 via a controller 1020. Computer-readable medium 1002 can be any device or medium that can store code and/or data for use by one or more processors 1018. Medium 1002 can include a memory hierarchy, including cache, main memory, and secondary memory.

Device 1000 also includes a power system 1042 for powering the various hardware components. Power system 1042 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management, and distribution of power in mobile devices.

In some embodiments, device 1000 includes a camera 1044. In some embodiments, device 1000 includes sensors 1046. Sensors 1046 can include accelerometers, compasses, gyrometers, pressure sensors, audio sensors, light sensors, barometers, altimeter, and the like. Sensors 1046 can be used to sense location aspects, such as auditory or light signatures of a location.

In some embodiments, device 1000 can include a GPS receiver, sometimes referred to as a GPS unit 1048. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 1000 may be configured to identify GLONASS signals, or any other similar type of satellite navigational signal.

One or more processors 1018 run various software components stored in medium 1002 to perform various functions for device 1000. In some embodiments, the software components include an operating system 1022, a communication module (or set of instructions) 1024, a location module (or set of instructions) 1026, an image processing module 1028, an odometry module 1030, and other applications (or set of instructions) 1034, such as a car locator app and a navigation app.

Operating system 1022 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1024 facilitates communication with other devices over one or more external ports 1036 or via wireless circuitry 1008 and includes various software components for handling data received from wireless circuitry 1008 and/or external port 1036. External port 1036 (e.g., USB, FireWire, Lightning connector, 60-pin connector, etc.) is adapted for coupling directly to other devices or indirectly over a network (e.g., the Internet, wireless LAN, etc.).

Location/motion module 1026 can assist in determining the current position (e.g., coordinates or other geographic location identifier) and motion of device 1000. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1026 receives data from GPS unit 1048 and analyzes the signals to determine the current position of the mobile device. In some embodiments, location/motion module 1026 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1008 and is passed to location/motion module 1026. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1000 based on the position coordinates of the corresponding transmitters. Regardless of the specific location technology used, location/motion module 1026 receives information from which a location fix can be derived, interprets that information, and returns location information, such as geographic coordinates, latitude/longitude, or other location fix data.

Image processing module 1028 can include various sub-modules or systems, e.g., as described herein with respect to FIGS. 2-7.

Odometry module 1030 can perform odometry techniques to determine the location and orientation of an electronic device within a physical environment. Output from the camera 1044 and the sensors 1046 can be accessed by the odometry module 1030, and the odometry module 1030 can use this information to perform visual inertial odometry techniques. The odometry module 1030 can identify and compare features in sequential images captured by camera 1044 to determine the camera's movement relative to those features. The odometry module 1030 may use information from the sequential images to create a map of the environment. In addition, or alternatively, inertial information from sensors 1046 can be used to estimate the movement of the electronic device. Inertial information can include any combination of linear acceleration, angular acceleration, linear velocity, angular velocity, and magnetometer readings, and the inertial information can be in any number of axes.

The one or more application programs 1034 on the mobile device can include any applications installed on the device 1000, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 1006 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1006 can include a display and user input devices such as a keyboard, mouse, and/or track pad. In some embodiments, I/O subsystem 1006 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 1002) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1000 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A method performed by a headset device, the method comprising:
capturing images using one or more cameras of the headset device;
tracking a controller operable to control the headset device using a first model based on the images;
tracking one or more hands of a user of the headset device using a second model based on the images;
determining a spatial relationship between the one or more hands and the controller;
determining the user is holding the controller based on the spatial relationship; and
responsive to determining the user is holding the controller, switching an input mode of the headset device from a hand mode to a controller mode such that the controller is operable to control the headset device.

2. The method of claim 1, wherein tracking the controller using the first model comprises:
detecting one or more lights arranged in a particular pattern on the controller in the captured images; and
determining location and orientation of the controller based on the detected one or more lights.

3. The method of claim 1, further comprising:
receiving inertial measurements performed by using one or more inertial sensors of the controller, wherein tracking the controller is further based based on the inertial measurements.

4. The method of claim 3, wherein the first model is configured to perform interpolation based on the images and the inertial measurements, wherein the interpolation comprises:
calculating an average between a first image and a second image of the captured images;
generating a third image based on the calculated average; and
adjusting the third image based on the inertial measurements between the first image and the second image.

5. The method of claim 3, wherein the first model is configured to perform prediction based on the images and the inertial measurements, wherein the prediction comprises:
identifying a changing pattern between a first image and a second image of the captured images; and
generating a third image based on the changing pattern and the second image.

6. The method of claim 1, wherein determining the spatial relationship uses the first model and the second model, wherein the spatial relationship comprises distance, moving directions, and speed between the controller and the one or more hands.

7. The method of claim 1, wherein determining the spatial relationship uses one or more proximity sensors, wherein the spatial relationship comprises changes in characteristics of the proximity sensors.

8. The method of claim 1, wherein determining the user is holding the controller based on the spatial relationship comprises performing a proximity threshold test comprising a threshold distance between the controller and the one or more hands.

9. The method of claim 8, wherein performing the proximity threshold test comprises checking shape of certain parts of the one or more hands.

10. The method of claim 1, wherein the controller is a right-hand controller or a left-hand controller, and wherein determining the user is holding the controller comprises:
determining a right hand of the user is holding the right-hand controller and a left hand of the user is holding the left-hand controller.

11. The method of claim 1, wherein determining the user is holding the controller comprises:
distinguishing whether a hand holding the controller is the user's hand or a non-user's hand by analyzing movement history of the hand holding the controller.

12. The method of claim 1, wherein switching the input mode of the headset device from the hand mode to the controller mode further comprises reducing a frequency of tracking the one or more hands using the second model.

13. A headset device comprising:
one or more processors; and
a memory coupled to the one or more processors, the memory storing instructions that cause the one or more processors to perform:
capturing images using one or more cameras of the headset device;
tracking a controller operable to control the headset device using a first model based on the images;
tracking one or more hands of a user of the headset device using a second model based on the images;
determining a spatial relationship between the one or more hands and the controller;
determining the user is holding the controller based on the spatial relationship; and
responsive to determining the user is holding the controller, switching an input mode of the headset device from a hand mode to a controller mode such that the controller is operable to control the headset device.

14. The headset device of claim 13, wherein tracking the controller using the first model comprises:
detecting one or more lights arranged in a particular pattern on the controller in the captured images; and
determining location and orientation of the controller based on the detected one or more lights.

15. The headset device of claim 13, wherein the instructions cause the one or more processors to further perform:
receiving inertial measurements performed by using one or more inertial sensors of the controller, wherein tracking the controller is further based on the inertial measurement.

16. The headset device of claim 13, wherein determining the user is holding the controller based on the spatial relationship comprises performing a proximity threshold test comprising a threshold distance between the controller and the one or more hands.

17. The headset device of claim 13, wherein determining the spatial relationship uses the first model and the second model, wherein the spatial relationship comprises distance, moving directions, and speed between the controller and the one or more hands.

18. The headset device of claim 13, wherein the controller is a right-hand controller or a left-hand controller, and wherein determining the user is holding the controller comprises:
determining a right hand of the user is holding the right-hand controller and a left hand of the user is holding the left-hand controller.

19. A non-transitory computer readable medium storing instructions that, when executed, on one or more processors perform:
capturing images using one or more cameras of a headset device;
tracking a controller operable to control the headset device using a first model based on the images;
tracking one or more hands of a user of the headset device using a second model based on the images;
determining a spatial relationship between the one or more hands and the controller;
determining the user is holding the controller based on the spatial relationship; and
responsive to determining the user is holding the controller, switching an input mode of the headset device from a hand mode to a controller mode such that the controller is operable to control the headset device.

20. The non-transitory computer readable medium of claim 19, wherein the instructions cause the one or more processors to further perform:
receiving inertial measurements performed by using one or more inertial sensors of the controller, wherein tracking the controller is further based on the inertial measurement.
